(19) United States
(12) Patent Application Publication
(10) Pub. No.: US 2020/0076953 A1
(43) Pub. Date: Mar. 5, 2020

(54) TELEPHONE SIGNAL PROCESSING

(71) Applicant: Semafone Limited, Surrey (GB)

(72) Inventors: Yufei Tao, Crowthorne (GB); Thomas Baldwin, Surrey (GB)

(21) Appl. No.: 16/496,298

(22) PCT Filed: Mar. 21, 2018
(86) PCT No.: PCT/GB2018/050736

§ 371 Date: Sep. 20, 2019

(30) Foreign Application Priority Data
Mar. 21, 2017 (GB) 1704489.2

(51) Int. Cl. H04M 7/12; H04M 11/06; H04M 7/00; H04M 9/08; H04M 1/50

(52) U.S. Cl. CPC H04M 7/1295; H04M 11/06; H04M 1/50; H04M 9/08; H04M 7/006

(57) ABSTRACT

A method of processing a telephone signal comprising voice signals and data signals, the method comprising detecting the presence of an artefact in the telephone signal indicative of the presence of a data signal fragment associated with an earlier attenuation of a data signal and processing the telephone signal by further attenuating the telephone signal in the region of the artefact in order to remove the data signal fragment from the telephone signal.

This invention relates to a method of and apparatus for the processing of telephone signals, more specifically to the removal of data signal fragments known as DTMF ‘bleed’. The invention may find application where DTMF tones are used to transmit sensitive data during a telephone call, in particular where it is desirable to ensure the DTMF tones are adequately blocked from reaching certain elements or parts of the telephone network.

Dual-tone multi-frequency (DTMF) is a telecommunication signalling system using the voice-frequency band over telephone lines between telephone equipment and other communications devices.

The 16 DTMF digits (0-9, A-D, * and #) are each represented by a different pair of audible tones comprising the following frequencies:

DTMF keypad frequencies

| | 1209 Hz | 1336 Hz | 1477 Hz | 1633 Hz |
|---|---|---|---|---|
| 697 Hz | 1 | 2 | 3 | A |
| 770 Hz | 4 | 5 | 6 | B |
| 852 Hz | 7 | 8 | 9 | C |
| 941 Hz | * | 0 | # | D |

These DTMF tones can be uniquely identified at a receiver through signal processing.

In-band DTMF tones sometimes need to be blocked or removed from the normal audio stream and/or converted into other formats for further processing, eg. in applications where traditional POTS telephony needs to interact with VoIP systems.

Sometimes the telephony devices responsible for detecting and removing in-band DTMF fail to remove the DTMF tones completely, causing a small portion of the in-band DTMF to remain in the audio stream. These small remnants or residual portions of the DTMF tones—which are usually of a much shorter duration than the original DTMF tones—are referred to as DTMF bleed(s).

DTMF bleed is frequently encountered when in-band DTMF digits from the telephone keypads in traditional telephone networks are converted into other formats, eg. out-of-band session initiation protocol (SIP) signalling, or event packets in a real-time transport protocol

(RTP) stream (eg. in accordance with RFC2833, the IETF standard for “RTP Payload for DTMF Digits, Telephony Tones and Telephony Signals”).

The common attitude towards DTMF bleeds is that they can be tolerated as long as their duration is not so long that they are detected as (new) DTMF digits. ITU standard Q.24 for “Multi-frequency push-button signal reception” states that generally the minimum duration of a DTMF tone is 40 milliseconds. It is therefore normal for DTMF bleeds of shorter duration not to be detected as DTMF tones.

Typically, the durations of DTMF bleeds introduced by various telephony devices are usually between a few to around 20 milliseconds in duration (some may be even longer). Such DTMF bleeds are commonly considered as acceptable according to the ITU standard and most telephony device vendors.

Although DTMF bleeds do not generally pose significant problems for most applications, they do potentially cause serious consequences for applications where sensitive data e.g. credit card numbers etc. is transmitted from telephone keypads via DTMF tones.

Examples of such systems are described in the applicant's UK patent GB2473376 (the contents of which are incorporated herein by reference).

In such cases any bleeding through of DTMF tones into unintended telephony path(s) may risk sensitive data being intercepted for malicious purposes.

For example, in experiments to establish the minimal duration of DTMF bleed which would nevertheless allow DTMF information to be recovered (using manual extraction and additional signal processing techniques applied to each individual bleed), DTMF information was successfully extracted from DTMF bleeds as short as 2-3 milliseconds. Unfortunately, this implies that most DTMF bleeds are long enough for malicious recovery and therefore ideally ought to be removed from the unintended telephony path(s) for any DTMF system considered to be secure.

In conventional DTMF detection, audio signals are captured in the time domain, are converted into the frequency domain and an attempt is made to identify any frequency pairs present within the processing frame which might define DTMF digits (eg. by comparing their signal strength to those of other frequency components).

However, this technique cannot be used to reliably identify DTMF bleed because the duration of DTMF bleed tones is too short for their constituent pairs of frequencies to be readily identified over other frequencies present in the audio signal.

This is especially so when the audio stream contains large amounts of noise, which may comprise unpredictable frequencies and signal strengths. If, in order to detect such short duration DTMF bleed tones, the detection event is set to trigger whenever a DTMF pair of frequencies is present, even if only momentarily, then as the amount of noise increases so does the probability that such a pair of frequencies will exist in the noise by chance, leading to spurious “detection” events.

While it is theoretically possible for the telephony devices to be optimised to avoid DTMF bleeding, this is largely out of the control of application developers who, as a result, have to handle audio streams containing bleeds. Since existing telephony devices cannot detect bleeds due to their short durations, adding extra telephony devices for bleed removal is not a viable solution.

In short, it is very challenging to detect and remove DTMF bleeds using conventional frequency domain methods.

There is therefore a need for better techniques to achieve DTMF bleed removal, ones which are preferably both more effective and easier to implement than conventional techniques.

According to one aspect of the invention, there is provided a method of processing a telephone signal comprising voice signals and data signals, the method comprising: detecting the presence of an artefact in the telephone signal indicative of the presence of a data signal fragment associated with an earlier attenuation of a data signal; and processing the telephone signal by further attenuating the telephone signal in the region of the artefact in order to remove the data signal fragment from the telephone signal.

Preferably, wherein the data signal comprises at least one of: an acoustic signal, acoustic signal according to an acoustic data transmission protocol, and a DTMF tone.

Preferably, attenuating the telephone signal in the region of the artefact comprises at least one of: omitting or dropping or deleting a portion of the telephone signal, replacing a portion of the telephone signal, and/or modifying a portion of the telephone signal.

Preferably, the method further comprises further attenuating the telephone signal only when data signal fragments are expected to be present.

Preferably, processing of the telephone signal occurs in the time domain.

Preferably, the artefact comprises a spike in the telephone signal, defined by the ratio of the maximum or peak amplitude of the telephone signal to the noise floor exceeding a threshold.

The terms artefact and spike may be used interchangeably.

The duration of the artefact or spike may be less than 40 milliseconds, less than 30 ms, less than 20 ms, less than 15 ms, less than 10 ms, less than 5 ms, less than 2 ms, less than 1 ms.

Frequency domain signal processing may be used to assist with artefact or spike detection.

Preferably, the method further comprises processing the telephone signal as a sequence of frames. Each frame may have a duration of 50 milliseconds or less, 40 milliseconds or less, 30 ms or less, 20 ms or less, 15 ms or less, 10 ms or less, 5 ms or less, 2 ms or less, 1 ms or less.

Preferably, the frame duration and/or position is determined by means of a neural network.

Preferably, the neural network is provided with an input comprising the pre-processed telephone signal and a training example comprising a telephone signal with an artefact determined from a telephony environment and/or artificially generated. A time-domain training example may be a ‘spike’ or the wave form of a few periods of the dual frequency signal.

The frame duration and/or position may be determined by a parameter in dependence on the telephone signal source.

The frames may be processed individually or in at least pairs and compared pairwise.

Preferably, attenuating the telephone signal in the region of the artefact comprises dropping the frame in which the artefact is detected. This may comprise replacing the frame in which the artefact or spike is detected. Alternatively, the frame may be replaced with a frame containing no artefact, or a frame containing a noise signal, or a copy of a previous frame or portion of a previous frame.

In a further embodiment, the artefact comprises a data packet in the telephone signal indicative of the presence of a data signal fragment associated with an earlier attenuation of a data signal, the method further comprising: buffering a first portion of the telephone signal;

on detection of an indicative data packet in a second portion of the telephone signal, deleting the buffered first portion of the telephone signal.

The indicative data packet may be, for example, a RFC 2833 packet, a RFC 4733 packet, a SIP INFO message, a SIP NOTIFY message, or a SIP KPML message or similar.

The duration of the buffered first portion of the telephone signal may be less than 300 milliseconds, less than 200 milliseconds, less than 100 milliseconds.

Preferably, the duration of the buffered first portion of the telephone signal buffered is such that the end-to-end delay of the system as a whole is less than 100 milliseconds.

The duration of the buffered first portion of the telephone signal may be determined in dependence on probability statistics of the delay between the arrival of data signal fragments and related indicative data packets.

The likelihood of data signal fragments may be determined in dependence on a probability function relating the likely presence of data signal fragments to the rate of receipt of data signals.

Artefact detection and indicative data packet methods may be used in combination.

Preferably, the data signals comprise sensitive information and/or transaction information.

Preferably, the method further comprises: receiving the voice signals and data signals at a first telephone interface and in a first mode, transmitting the voice signals and the data signals via a second telephone interface; and in a second mode, attenuating the data signals and optionally transmitting the voice signals via the second telephone interface.

Optionally, the method further comprises: generating a request based on said transaction information; transmitting said request via a data interface to an external entity; receiving a message from the entity via the data interface to identify success or failure of the request; and processing the transaction information signals in dependence on the success or failure of the request.

According to another aspect of the invention there is provided a telephone call processor for processing telephone calls comprising voice signals and data signals, the call processor being adapted to: receive voice signals and data signals at a first telephone interface; detect the presence of an artefact in the telephone signal indicative of the presence of a data signal fragment associated with an earlier attenuation of a data signal; process the telephone signal by further attenuating the telephone signal in the region of the artefact in order to remove the data signal fragment from the telephone signal; and transmit the processed voice signals and data signals via a second telephone interface.

Preferably, the call processor is adapted to attenuate the telephone signal in the region of the artefact by means of at least one of: a) omitting or dropping or deleting a portion of the telephone signal, b) replacing a portion of the telephone signal, and/or c) modifying a portion of the telephone signal.

The call processor may be adapted to attenuate the telephone signal only when data signal fragments are expected to be present.

Preferably, the call processor is adapted to process the telephone signal in the time domain.

Preferably, the call processor is further adapted to use frequency domain signal processing to assist with artefact or spike detection.

Preferably, the call processor is further adapted to process the telephone signal as a sequence of frames. Each frame may have a duration of 50 milliseconds or less, 40 milliseconds or less, 30 ms or less, 20 ms or less, 15 ms or less, 10 ms or less, 5 ms or less, 2 ms or less, 1 ms or less.

Preferably, the call processor is adapted so that the frame duration and/or position is determined by means of a neural network.

Preferably, the call processor is adapted so that the neural network is provided with an input comprising the pre-processed telephone signal and a training example comprising a telephone signal with an artefact determined from a telephony environment and/or artificially generated.

Preferably, the call processor is adapted so that the frame duration and/or position is determined by a parameter in dependence on the telephone signal source.

The call processor may process the frames individually or in at least pairs and compare the frames pairwise.

Preferably, the call processor is further adapted to attenuate the telephone signal in the region of the artefact by dropping the frame in which the artefact is detected.

The call processor may be further adapted to attenuate the telephone signal in the region of the artefact by replacing the frame in which the artefact is detected and/or to replace the frame with a frame containing no artefact, or a frame containing a noise signal, or a copy of a previous frame or portion of a previous frame.

Preferably, the artefact comprises a data packet in the telephone signal indicative of the presence of a data signal fragment associated with an earlier attenuation of a data signal, and the call processor is further adapted to: buffer a first portion of the telephone signal; on detection of an indicative data packet in a second portion of the telephone signal, delete the buffered first portion of the telephone signal.

Preferably, the call processor is adapted to determine the duration of the buffered first portion of the telephone signal in dependence on probability statistics of the delay between the arrival of data signal fragments and related indicative data packets.

Preferably, the call processor is adapted to determine the likelihood of data signal fragments in dependence on a probability function relating the likely presence of data signal fragments to the rate of receipt of data signals.

The call processor may be adapted for artefact detection and indicative data packet methods to be used in combination.

Preferably, the call processor is further adapted to: receive the voice signals and data signals at a first telephone interface and in a first mode, transmit the voice signals and the data signals via a second telephone interface; and in a second mode, attenuate the data signals and optionally transmit the voice signals via the second telephone interface.

Optionally, the call processor may be further adapted to: generate a request based on said transaction information; transmit said request via a data interface to an external entity; receive a message from the entity via the data interface to identify success or failure of the request; and process the transaction information signals in dependence on the success or failure of the request.

Generally, there is provided apparatus for carrying out any of the methods described.

Further features of the invention are characterised by the dependent claims.

The invention also provides a computer program and a computer program product for carrying out any of the methods described herein, and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied apparatus aspects, and vice versa.

Equally, the invention may comprise any feature as described, whether singly or in any appropriate combination.

Furthermore, features implemented in hardware may generally be implemented in software, and vice versa. Any reference to software and hardware features herein should be construed accordingly.

The invention will now be described, purely by way of example, with reference to the accompanying drawings, in which:

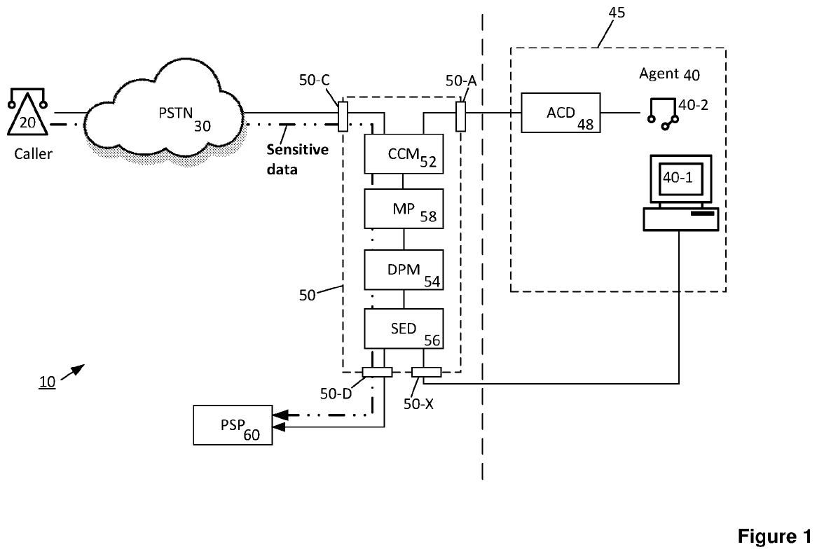

FIG. 1 shows part of a telephony system, wherein a caller is in communication over a communications network with an agent such as those employed in a call centre;

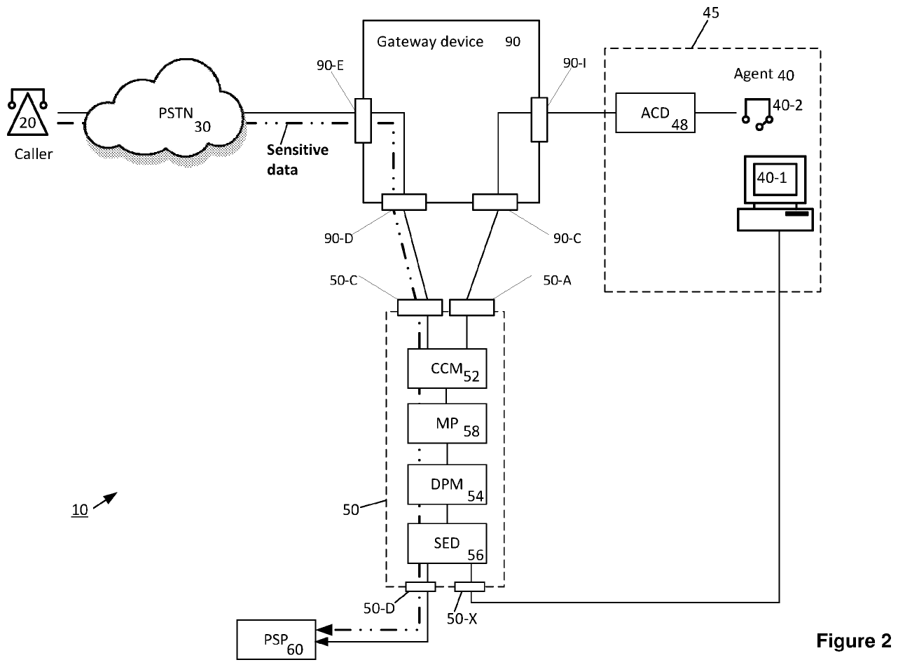

FIG. 2 shows another embodiment of a telephony system;

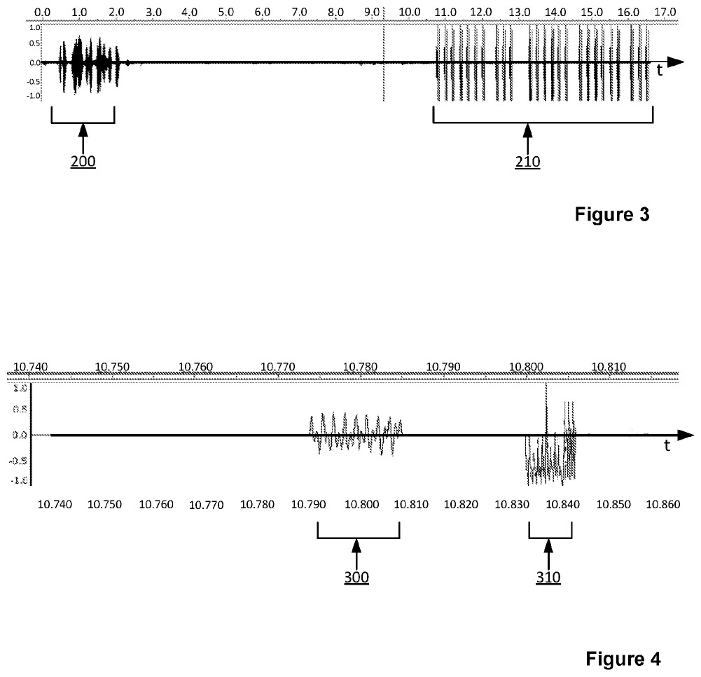

FIG. 3 shows an example time-domain amplitude plot of a telephone call with ‘blocked’ DTMF tones;

FIG. 4 shows a zoom-in plot of the first artefact or spike in FIG. 3;

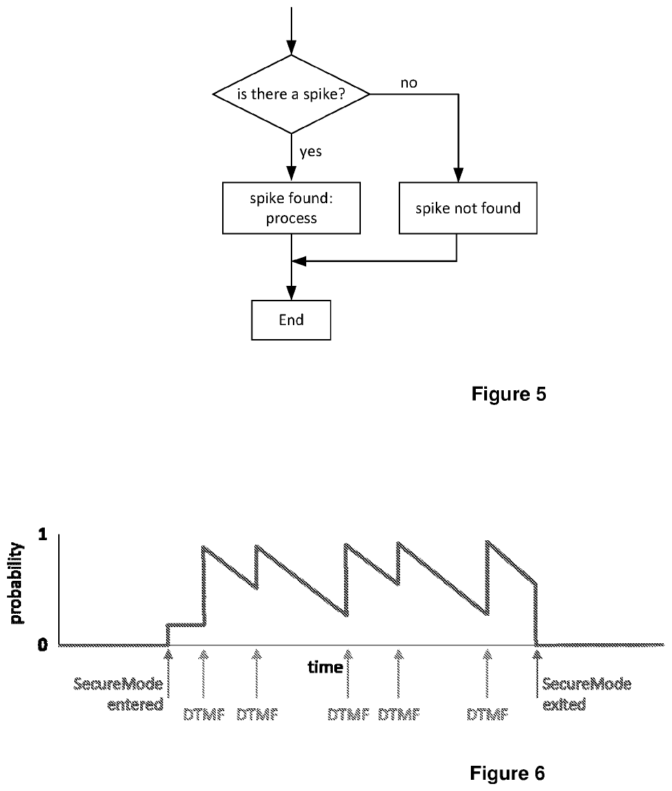

FIG. 5 shows the basic logic for time-domain DTMF bleed removal; and

FIG. 6 shows an example of a bleed probability function.

### OVERVIEW

FIG. 1 shows part of a telephony system 10, wherein a caller 20 is in communication over a communications network 30 with an agent 40 such as those employed in a call centre. The call is relayed via a call processor 50 supplied by a secure DTMF service provider.

The call processor 50 may, for example, be similar to that described in the applicant's UK patent GB2473376, in this example comprising a first, caller-facing telephone interface 50-C, second, agent-facing telephone interface 50-A and a data interface 50-D for communicating with an external entity 60 for say authentication/authorisation. Additional interfaces 50-X may be provided for telephone and/or data, for example for allowing the agent 40 to trigger operation or mode-switching of elements of the call processor 50 from the agent computer 40-1. In some embodiments the functionality of one or more interfaces 50-A, 50-C, 50-D, 50-X may be combined in a single interface or divided between multiple interfaces.

Typically, the call processor 50 comprises constituent components such as a Call Control Module (CCM) 52, Data Processing Module (DPM) 54 and security device (SED) 56. The call processor 50 or one or more of its constituent components may be located within the call centre or external to it.

Where external entity 60 is a payment service provider (PSP) this may thus allow for the agent 40 to process card payments made by the caller 20 during a phone call, with sensitive data (eg. card details) provided by the caller 20 via DTMF tones being processed by the call processor 50 such that they are prevented from propagating to the agent 40. The caller 20 and agent 40 may remain in voice communication throughout—or for a substantial part of—the call.

In more detail:
Usually, during a voice call, audio (DTMF) tones are passed through (via the Call Control Module, CCM) from Caller 20 to the Contact Centre 45 (for example, to allow navigation of an interactive voice response or IVR menu system) and, via an Automatic Call Distributor (ACD) 48, to the Agent 40.
When a card payment is to be made, the Agent 40 places the call processor 50 into ‘secure mode’ by sending a triggering signal (eg. ‘#’) from the Agent computer 42 to the DPM 54. This instructs the CCM 52 to block transmission of DTMF tones to the Agent during the immediately following period in which the Caller is entering sensitive data (eg. payment card data).
In addition, for some embodiments, while the Caller 20 is entering sensitive data during secure mode, audio ‘masking tones’ are transmitted to the Agent headset 40-2 to cover any ‘bleed’ of DTMF tones into the audio stream which may occur—these may also act as an audio progress indicator for the Agent 40.
In some embodiments, a visual progress indicator is displayed on the Agent computer 40-1, usually in the form of characters such as a ‘*’ per digit entered by the Caller 20. Alternatively, or in addition, indicators may be used only to signal the stage and/or completion of the process.
In some embodiments, a media proxy (MP) 58 is used to remove all traces of DTMF at the call processor 50—in which case masking tones may not be used.
Being able to receive DTMF in binary format is the preferred option when using a media proxy (MP).
Forwarding of data between the CCM 52, DPM 54, security device SED 56 and the PSP 60 is essentially in ASCII format, albeit repackaged eg. as UTF-8, HTML etc.

Some telephone networks, particularly those of large network providers, are relatively homogenous or at least adhere to strict protocols such that there are essentially no issues with DTMF bleed.

Increasingly often, however, telephone networks are heterogeneous, with a mixture of different protocols. DTMF tones may be converted into different ASCII/binary formats as a matter of course during various stages of transmission through the telephony/computer network and subsequently reconstructed into audible tones. This may occur for example when SIP-only networks carrying DTMF in signalling formats (out-of-band SIP signalling or RFC2833)—which would in principle be immune from issues of DTMF bleed—are integrated with networks making use of other protocols.

As discussed above, there may therefore be circumstances wherein DTMF ‘bleed’ occurs, which may allow for sensitive information to be reconstructed from portions or remnants of DTMF signals which nevertheless propagate through to the call centre 45 and/or agent 40.

FIG. 2 shows a variant of the arrangement shown in FIG. 1, where a gateway device 90 is arranged between the call processor 50 and the communications network 30.

The gateway device 90 may be a session border controller (SBC) as often used for environments where all telephony connections are made using SIP; the gateway device 90 may be a protocol-converting device (eg. where the connections to the communications network 30 and to the agent 40 are made using a protocol which the call processor 50 does not natively support, for example ISDN). One example of such a protocol converting device is the Integrated Services Router (ISR) product range from Cisco.

In the arrangement illustrated in FIG. 2 telephony (media and signalling) potentially containing sensitive data is received from the communications network 30 at a caller-facing interface 90-E of a gateway device 90. The gateway device 90 routes the call (or converts and routes the call) via a ‘dirty’ interface 90-D to the caller-facing telephone interface 50-C of the call processor 50. The call is routed back to the gateway device 90 via a ‘clean’ interface 90-C from an agent-facing telephone interface 50-A of the call processor 50.The gateway device 90 then routes the call (or converts and routes the call) onward to the agent 40 via its agent-facing interface 90-I. In some embodiments the functionality of one or more interfaces 90-E, 90-D, 90-C, 90-I may be combined in a single interface or divided between multiple interfaces. The call processor 50 is as described above.

At any or none of the internal routing stages in the gateway device 90, the gateway device 90 may optionally perform protocol conversion or interworking tasks on the call.

### Time-Domain DTMF Bleed Removal

Experiments have shown that DTMF bleed signals have certain distinctive characteristics in the time-domain. One is that they tend to comprise artefacts such as ‘spikes’ or sharp bursts of signals, whereas the normal audio signals do not usually exhibit such prominent characteristics.

FIG. 3 shows an example time-domain amplitude plot of a telephone call with ‘blocked’ DTMF tones. Normal speech 200 is visible for the first few seconds followed by a series of sharp spikes 210 related to DTMF bleeds.

FIG. 4 shows a zoom-in plot of the first artefact or spike in FIG. 3. DTMF bleed spikes 300 of over 10 milliseconds are visible along with a noise burst 310 which does not contain either normal audio or DTMF information.

FIG. 5 shows the basic logic for time-domain DTMF bleed removal.

The basic idea of the method is to determine the time-domain characteristics of the bleed signals that differentiate them from normal audio signals, and process signals that exhibit such characteristics.

Generally, the aim is to detect the ‘spikes’ in the audio stream characteristic of DTMF bleed and process the signal in the vicinity sufficiently in order to remove or replace the spike while leaving any speech in the signal unaffected.

Typically, different call sources, for example originating from different telephone networks, will have different DTMF bleed characteristics and a plurality of call processors (or DTMF bleed removal processors) may be required specific to the characteristic DTMF bleed. For example, a different processing algorithm may be used for each particular characteristic DTMF bleed, or a common algorithm may be adapted with parameters specific to each particular characteristic DTMF bleed.

As mentioned, even if DTMF are not reliably detected by telephony devices (e.g. after going through some codecs such G729) at least some may still be detectable manually or by applying different detection thresholds. The bleed removal described here can be used to remove residual spikes regardless of the prior processing. The spike identification threshold may be selected appropriately to avoid excessive false spike identification.

In some embodiments, the telephone signal is processed as a sequence of 20 ms frames, as used in the standard G.711 Pulse Code Modulation (PCM) waveform codec. Most DTMF bleeds are found to lie within a single frame of this size; in one example, it was observed that spikes are typically of 13 ms or less duration. As used herein, unless otherwise specified, the frames referred to are processing frames used in time-domain DTMF bleed removal, and not for example speech frames of an audio codec.

Frames may be considered individually or in groups of two or more. In the latter, one frame may be buffered and compared pairwise with a following frame.

When the ‘spikes’ are detected they are removed regardless whether they contain DTMF information or not, ie. the decision whether to drop a frame is binary: if a spike is detected the frame is dropped.

In this example, both the real bleed 300 and the noise burst 310 would be removed. Since normal audio signals do not usually contain ‘spikes’, with a suitable choice of parameters such normal audio signals are left largely intact.

In some circumstances, spikes may span the boundary between two consecutive frames, requiring both frames to be dropped and loss of up to 40 ms of audio. This may result in a noticeable interruption to speech but this is likely to nevertheless be considered acceptable in view of the risk of otherwise allowing sensitive information to be disclosed via DTMF bleed, ie. during “secure mode”.

The bleed detection method based on recognition of the signal characteristics may be carried out using different approaches, eg.
manual parameter approach: by manually defining the parameters describing the characteristics of spike and the surrounding audio signal; or
neural network approach: by deploying pre-trained neural network(s), with the input being the original or pre-processed audio signal; the training examples of the neural network may be real bleed signals from telephony environments, artificially generated or a combination of both. A time-domain training example may be a ‘spike’ or the wave form of a few periods of the dual frequency signal.

There are several practical considerations regarding the manual parameter approach:

### Defining a ‘Spike’

Spikes are generally understood to be ‘high and narrow’ but their detection will be determined by how this is defined by various parameters eg. amplitude, power, duration etc. Different choices of parameters and values will lead to different results. These parameters can be selected and optimised to suit a specific telephony set up such that a satisfactory rate of bleed removal is achieved and acceptable audio quality is maintained after the processing.

### Noise

The presence of noise may have significant impact on the identification of the spikes. We may identify two different types of noise:
background noise, ie. a base level of noise throughout the telephone signal, also referred to as the signal having a high noise ‘floor’
noise bursts, ie. noise localized in the vicinity of the spikes/bleeds

Typically, spikes are identified where the ratio of the maximum or peak amplitude A (or related quantity such as power) to noise floor N exceeds a threshold, ie.

$$\frac{\vert {A}_{max} \vert}{N} > Threshold$$

The selection of a suitable threshold value generally depends considerably on the specific telephony system, and may be determined for a particular call processor 50 by testing. For one telephony system a threshold value of for example 100 may be suitable, whereas for another telephony system a very different threshold value may be suitable.

A high noise floor can necessitate selection of a relatively low threshold, which gives rise to higher probabilities of false alarm (normal audio detected as spikes and removed), causing degradation of audio quality. Various techniques may be used to alleviate problems introduced by high noise floors. For example, frequency domain signal processing techniques may be applied in addition to the said algorithm for spike identification, to reduce false alarms by only removing the ‘spike’ if its frequency spectrum shows high probability of containing DTMF frequency components.

Noise bursts may be addressed by various techniques. For example, different positioning of the processing frame (instead of using static processing windows) can assist in reducing the effect of noise bursts on spike identification. Data (single frame or multiple buffered frames) can be searched through using processing windows of different sizes and positions to capture spikes that may otherwise be (partly) missed. This can assist in identifying spikes that reside across a boundary of a processing window; or spikes that reside closely to other spikes (such as noise bursts).

### Audio Quality

As with any signal processing technique, spike removal will result in modifications to the audio signal.

In some embodiments, the DTMF bleed-removal algorithm is only applied when DTMF signals are known to be being entered by the caller 20. This reduces the potential risk of control signals or even elements of the voice of the caller being detected as DTMF bleed and removed.

In some embodiments, the removal of spikes may be used to enhance the quality of or otherwise alter the audio signal, for example by removing interference, noise (in particular bursty or spikey noise) etc.

If the algorithm is applied to the whole duration of the audio stream, satisfactory audio quality is maintained by proper choice of parameters that control the bleed removal.

### Advantages

Potential advantages of the time-domain method may include one or more of the following:
Well-suited for handling narrow bleeds where conventional ‘frequency domain algorithm’ struggles most.
Minimises the impact on normal audio as it only removes signals with bleed characteristics that are not usually present in normal audio, rather than silencing out all audio as may be the case with some embodiments of the ‘buffering and backup’ algorithm described below.
Relatively simple to implement
Computationally light
Does not rely on external triggers
Does not require buffering for most cases where bleeds are very short and thus does not introduce a large latency into the audio signal.

### Extensions

The method may be extended in various ways to improve the bleed removal performance or (further) reduce the computational cost. Some examples are:
Use of processing frames of different durations; in order to achieve this additional buffering of the signal may be provided; for example using longer processing frames may allow more effective handling of bleeds of longer duration, and using processing frames of different sizes and positions can improve spike detection as discussed above.
External triggers may be used to turn the bleed removal algorithm on/off (ie. turning on bleed detection and removal only during secure mode) or modify the bleed detection parameters.
Signal evaluation in the frequency domain may be included, eg. for bleeds with longer durations, or to address high noise floor as discussed above.
In some embodiments, bleed detection and removal would be active throughout the call.
Instead of removing the spikes they may be replaced with silence or they may be replaced with a signal, for example a signal that matches the background noise such that the removal of the bleed is less obvious to the parties on the phone call, such as a previous frame or a fragment of a previous frame; the spikes may also be replace with other audio data such as a pre-recorded audio file (e.g. a tone or comfort noise).
The signal processing may be applied to other acoustic signal tones not according to the DTMF protocol; for example acoustic transmissions according to an acoustic data transmission protocol may be processed to remove signal bleed.

### Buffering and Backup DTMF Bleed Removal

Another way to remove bleeds relies on determining the approximate timing of DTMF bleeds from the receipt of notification of DTMF events, for example from RFC2833 packets (or comparable, where available, e.g. RFC 4733). This may be performed by the media proxy (MP) 58 as shown in FIG. 1 or 2 to remove traces of DTMF at the call processor 50, in addition to or alternative to the time-domain DTMF bleed removal process described above.

In this alternative, sufficient audio needs to be buffered so that when the notification of a DTMF event is received (eg a first RFC 2833 packet for the DTMF digit is received), the previously buffered audio is silenced (or attenuated, e.g. by dropping or replacing as described above) because it may contain DTMF bleed. Since the DTMFs are expected imminently, such silencing causes only a relatively short loss of speech (due the audio being silenced in proximity to an incoming DTMF tone). In practice, this is likely to be no worse than the drops commonly experienced on mobile calls, and intelligibility should not be significantly compromised.

Since the delay between the DTMF bleed and its corresponding first RFC 2833 packet is undefined and varies for different devices, the appropriate amount of buffering may vary, and a suitable buffer for one setup may not perform as well for a different setup. A larger buffer helps in effective bleed removal but introduces longer delay into the audio stream which may affect the quality of the call. Generally, it is understood that an audio delay (latency) in the telephony path in the range of 150-200 milliseconds will start to be noticeable and when it exceeds 300 milliseconds the quality is considered poor. Consequently, a buffer of less than 300 milliseconds, preferably less than 200 milliseconds or less than 100 milliseconds is used.

The delay between the DTMF bleed and its corresponding first RFC 2833 packet for a particular telephony set up may be measured (and for example associated with an IP address of a media origin or sender) and used in determining an optimal buffer size. Over time, statistics can be gathered regarding the performance of specific endpoints; this information can be used to characterise the temporal relationship between the DTMF notification being received and the highest probability of a DTMF bleed event, in order to compile a library of appropriate buffer sizes for different connections.

In a variant, the silencing of the audio is refined by taking a bleed probability function into account that is based on receipt of per digit notifications in relation to the DTMF. If a digit notification has just been received, the probability of a bleeding fragment in the last few samples is much higher than when a period of time has elapsed since a digit notification was seen.

FIG. 6 shows an example of a bleed probability function. This probability function can be used as the basis of a confidence threshold to assist a DTMF detection algorithm in deciding when to silence audio. The bleed probability function depends on the latency associated with a particular telephony set up, which can be measured and used to characterise the temporal relationship between the DTMF notification being received and the highest probability of a DTMF bleed event.

In a further variant, when notification of a DTMF event is received the buffered audio is additionally processed according to the time-domain DTMF bleed removal process described above. In this variant the time-domain processing for spike identification only occurs when notification of a DTMF event is received. This can enable reduction of the computational load compared to continuous processing of the audio for spike removal, and avoid unnecessary silencing of the audio.

It will be understood that the invention has been described above purely by way of example, and modifications of detail can be made within the scope of the invention.

Reference numerals appearing in any claims are by way of illustration only and shall have no limiting effect on the scope of the claims.

1. A method of processing a telephone signal comprising voice signals and data signals, the method comprising:
detecting the presence of an artefact in the telephone signal indicative of the presence of a data signal fragment associated with an earlier attenuation of a data signal; and
processing the telephone signal by further attenuating the telephone signal in the region of the artefact in order to remove the data signal fragment from the telephone signal.

2. A method according to claim 1, wherein the data signal comprises at least one of:
a) an acoustic signal,
b) acoustic signal according to an acoustic data transmission protocol, and
c) a DTMF tone.

3. A method according to claim 1 or 2, wherein attenuating the telephone signal in the region of the artefact comprises at least one of:
a) omitting or dropping or deleting a portion of the telephone signal,
b) replacing a portion of the telephone signal, and/or
c) modifying a portion of the telephone signal.

4. A method according to any preceding claim, further comprising further attenuating the telephone signal only when data signal fragments are expected to be present.

5. A method according to any preceding claim, wherein processing of the telephone signal occurs in the time domain.

6. A method according to any preceding claim, wherein the artefact comprises a spike in the telephone signal, defined by the ratio of the maximum or peak amplitude of the telephone signal to the noise floor exceeding a threshold.

7. A method according to claim 6, wherein the duration of the artefact is less than 40 milliseconds, less than 30 ms, less than 20 ms, less than 15 ms, less than 10 ms, less than 5 ms, less than 2 ms, less than 1 ms.

8. A method according to claim 6 or 7, further comprising the use of frequency domain signal processing to assist with artefact detection.

9. A method according to any of claims 6 to 8, further comprising processing the telephone signal as a sequence of frames.

10. A method according to claim 9, wherein each frame has a duration of 50 milliseconds or less, 40 milliseconds or less, 30 ms or less, 20 ms or less, 15 ms or less, 10 ms or less, 5 ms or less, 2 ms or less, 1 ms or less.

11. A method according to claim 10, wherein the frame duration and/or position is determined by means of a neural network.

12. A method according to claim 11, wherein the neural network is provided with an input comprising the pre-processed telephone signal and a training example comprising a telephone signal with an artefact determined from a telephony environment and/or artificially generated.

13. A method according to any of claims 10 to 12, wherein the frame duration and/or position is determined by a parameter in dependence on the telephone signal source.

14. A method according to any of claims 9 to 13, wherein the frames are processed individually.

15. A method according to any of claims 9 to 13, wherein the frames are processed in at least pairs and compared pairwise.

16. A method according to claims 9 to 15, wherein further attenuating the telephone signal in the region of the artefact comprises dropping the frame in which the artefact is detected.

17. A method according to claims 9 to 15, wherein further attenuating the telephone signal in the region of the artefact comprises replacing the frame in which the artefact is detected.

18. A method according to claims 9 to 15, wherein the frame is replaced with a frame containing no artefact, or a frame containing a noise signal, or a copy of a previous frame or portion of a previous frame.

19. A method according to any of claims 1 to 5 wherein the artefact comprises a data packet in the telephone signal indicative of the presence of a data signal fragment associated with an earlier attenuation of a data signal, the method further comprising:
buffering a first portion of the telephone signal;
on detection of an indicative data packet in a second portion of the telephone signal, deleting the buffered first portion of the telephone signal.

20. A method according to claim 19, wherein the indicative data packet is one of: a RFC 2833 packet, a RFC 4733 packet, a SIP INFO message, a SIP NOTIFY message, or a SIP KPML message or similar.

21. A method according to claim 19 or 20, wherein the duration of the buffered first portion of the telephone signal is less than 300 milliseconds, less than 200 milliseconds, less than 100 milliseconds.

22. A method according to claim 21, wherein the duration of the buffered first portion of the telephone signal buffered is such that the end-to-end delay of the system as a whole is less than 100 milliseconds.

23. A method according to any of claims 19 to 22, wherein the duration of the buffered first portion of the telephone signal is determined in dependence on probability statistics of the delay between the arrival of data signal fragments and related indicative data packets.

24. A method according to any of claims 19 to 23, wherein the likelihood of data signal fragments is determined in dependence on a probability function relating the likely presence of data signal fragments to the rate of receipt of data signals.

25. A method according to any of claims 19 to 24 followed by the method according to any of claims 6 to 18.

26. A method according to any preceding claim, wherein the data signals comprise sensitive information and/or transaction information.

27. A method according to any preceding claim, the method further comprising:
receiving the voice signals and data signals at a first telephone interface and in a first mode, transmitting the voice signals and the data signals via a second telephone interface; and
in a second mode, attenuating the data signals and optionally transmitting the voice signals via the second telephone interface.

28. A method according to claim 27, further comprising:
generating a request based on said transaction information;
transmitting said request via a data interface to an external entity;
receiving a message from the entity via the data interface to identify success or failure of the request; and
processing the transaction information signals in dependence on the success or failure of the request.

29. A telephone call processor for processing telephone calls comprising voice signals and data signals, the call processor being adapted to:
receive voice signals and data signals at a first telephone interface;
detect the presence of an artefact in the telephone signal indicative of the presence of a data signal fragment associated with an earlier attenuation of a data signal;
process the telephone signal by further attenuating the telephone signal in the region of the artefact in order to remove the data signal fragment from the telephone signal; and
transmit the processed voice signals and data signals via a second telephone interface.

30. A call processor according to claim 29, wherein the data signal comprises at least one of:
d) an acoustic signal,
e) acoustic signal according to an acoustic data transmission protocol, and
f) a DTMF tone.

31. A call processor according to claim 29 or 30, adapted to attenuate the telephone signal in the region of the artefact by means of at least one of:
d) omitting or dropping or deleting a portion of the telephone signal,
e) replacing a portion of the telephone signal, and/or
f) modifying a portion of the telephone signal.

32. A call processor according to any of claims 29 to 31, adapted to attenuate the telephone signal only when data signal fragments are expected to be present.

33. A call processor according to any of claims 29 to 32, adapted to process the telephone signal in the time domain.

34. A call processor according to any of claims 29 to 33, wherein the artefact comprises a spike in the telephone signal, defined by the ratio of the maximum or peak amplitude of the telephone signal to the noise floor exceeding a threshold.

35. A call processor according to claim 34, wherein the duration of the artefact is less than 40 milliseconds, less than 30 ms, less than 20 ms, less than 15 ms, less than 10 ms, less than 5 ms, less than 2 ms, less than 1 ms.

36. A call processor according to claim 34 or 35, further adapted to use frequency domain signal processing to assist with artefact detection.

37. A call processor according to any of claims 34 to 36, further adapted to process the telephone signal as a sequence of frames.

38. A call processor according to claim 37, wherein each frame has a duration of 50 milliseconds or less, 40 milliseconds or less, 30 ms or less, 20 ms or less, 15 ms or less, 10 ms or less, 5 ms or less, 2 ms or less, 1 ms or less.

39. A call processor according to claim 38, adapted so that the frame duration and/or position is determined by means of a neural network.

40. A call processor according to claim 39, adapted so that the neural network is provided with an input comprising the pre-processed telephone signal and a training example comprising a telephone signal with an artefact determined from a telephony environment and/or artificially generated.

41. A call processor according to claim 38, adapted so that the frame duration and/or position is determined by a parameter in dependence on the telephone signal source.

42. A call processor according to any of claims 37 to 41, adapted to process the frames individually.

43. A call processor according to any of claims 37 to 41, adapted to process the frames in at least pairs and to compare the frames pairwise.

44. A call processor according to claims 37 to 43, further adapted to attenuate the telephone signal in the region of the artefact by dropping the frame in which the artefact is detected.

45. A call processor according to claims 37 to 43, further adapted to attenuate the telephone signal in the region of the artefact by replacing the frame in which the artefact is detected.

46. A call processor according to claims 37 to 43, adapted to replace the frame with a frame containing no artefact, or a frame containing a noise signal, or a copy of a previous frame or portion of a previous frame.

47. A call processor according to any of claims 29 to 33 wherein the artefact comprises a data packet in the telephone signal indicative of the presence of a data signal fragment associated with an earlier attenuation of a data signal, and the call processor is further adapted to:
buffer a first portion of the telephone signal;
on detection of an indicative data packet in a second portion of the telephone signal, delete the buffered first portion of the telephone signal.

48. A call processor according to claim 29, wherein the indicative data packet is one of: a RFC 2833 packet, a RFC 4733 packet, a SIP INFO message, a SIP NOTIFY message, or a SIP KPML message or similar.

49. A call processor according to claim 29 or 30, wherein the duration of the buffered first portion of the telephone signal is less than 300 milliseconds, less than 200 milliseconds, less than 100 milliseconds.

50. A call processor according to claim 31, wherein the duration of the buffered first portion of the telephone signal buffered is such that the end-to-end delay of the system as a whole is less than 100 milliseconds.

51. A call processor according to any of claims 29 to 32, adapted to determine the duration of the buffered first portion of the telephone signal in dependence on probability statistics of the delay between the arrival of data signal fragments and related indicative data packets.

52. A call processor according to any of claims 29 to 33, adapted to determine the likelihood of data signal fragments in dependence on a probability function relating the likely presence of data signal fragments to the rate of receipt of data signals.

53. A call processor according to any of claims 29 to 34 further adapted according to any of claims 34 to 46.

54. A call processor according to any of claims 29 to 53, wherein the data signals comprise sensitive information and/or transaction information.

55. A call processor according to any of claims 29 to 54, the call processor further adapted to:
receive the voice signals and data signals at a first telephone interface and
in a first mode, transmit the voice signals and the data signals via a second telephone interface; and
in a second mode, attenuate the data signals and optionally transmit the voice signals via the second telephone interface.

56. A call processor according to claim 55, further adapted to:
generate a request based on said transaction information;
transmit said request via a data interface to an external entity;
receive a message from the entity via the data interface to identify success or failure of the request; and
process the transaction information signals in dependence on the success or failure of the request.
